(19) United States
(12) Patent Application Publication
(10) Pub. No.: US 2007/0017447 A1
(43) Pub. Date: Jan. 25, 2007

(54) Avian eggshell membrane polypeptide extraction via fermentation process

(75) Inventor: Vladimir Vlad, Ames, IA (US)

Correspondence Address: MCKEE, VOORHEES & SEASE, P.L.C., 801 GRAND AVENUE, SUITE 3200, DES MOINES, IA, 50309-2721, US

(73) Assignee: BIOVA, L.L.C., Johnston, IA (US)

(21) Appl. No.: 11/471,766

(22) Filed: Jun. 21, 2006

Related U.S. Application Data
(60) Provisional application No. 60/692,706, filed on Jun. 21, 2005.

(51) Int. Cl. A01K 45/00

(52) U.S. Cl. 119/6.8

(57) ABSTRACT

A method of extracting a polypeptide from avian eggshell membranes. The method includes fermenting the avian eggshell membranes in a fermentation process, harvesting a fermented product, and processing the fermented product to extract the polypeptide. Prior to fermentation, the eggshell membranes are separated. Optionally, the eggshell membranes are dried. The processing of the fermented product can extract collagen, amino acids, or other high value polypeptides. Separating the eggshell membranes from eggshells may be performed using an acidic solution to assist in eliminating contaminants.

### RELATED APPLICATIONS

This application claims priority to U.S. Provisional Patent Application No. 60/692,706, filed Jun. 21, 2005, herein incorporated by reference in its entirety.

### BACKGROUND OF THE INVENTION

The present invention relates to the extraction and isolation of polypeptides from avian eggshell membranes, including the extraction of high value materials such as collagen, hyaluronic acid, amino acids, etc. Approximately 10 percent of an eggshell membrane is collagen type I, V, and X. The eggshell membrane also contains other compositions of value. Collagen has a number of biomedical uses, including in skin grafts, tissue replacement products, plastic surgery, angioplasty sleeves, cornea repair, prosthetic implants, and other applications. Collagen is also used in the cosmetic industry.

Collagen constitutes about 20 to 30 percent of the total body protein in vertebrates. It is a fibrous protein and functions primarily as a supporting tissue and scaffolding for other proteins and cells. It is present throughout the body but exists in high concentrations in skin, tendon, and bone.

Collagen is recovered from these tissues by a variety of techniques the oldest known method being the boiling of the tissue in water which denatures some of the collagen and forms the well-known gelatin upon cooling. For use as a biomaterial, however, collagen must be recovered in native, undenatured form, with little or no destruction of the basic rigid triple helical structure (tropocollagen).

Undenatured native collagen is recovered principally by two methods. The first method is in solution by dissolving the collagen in acids, bases, salts, or by enzyme digestion in which case the collagen becomes actually dissolved. The second method involves extraction in solid, undissolved, fiber form usually by the action of aqueous salt on minced, comminuted collagen raw material to produce a dispersion from which the solid is recovered by centrifuge.

Therefore it is a primary object, feature, or advantage of the present invention to improve upon the state of the art.

It is a further object, feature, or advantage of the present invention to provide for extraction or isolation of various polypeptide materials from egg shell membranes, including protein and amino acids.

It is a further object, feature, or advantage of the present invention to reduce waste used in egg processing.

Yet another object, feature, or advantage of the present invention is to produce collagen from what would otherwise be egg processing waste material.

A still further object of the present invention is to produce new revenue streams for hatcheries and egg producers.

A still further object, feature, or advantage of the present invention is to provide a method that reduces pathogens in eggshell membranes.

One or more of these and/or other objects, features, and advantages of the present invention will become apparent from the specification and claims that follow.

### BRIEF SUMMARY OF THE INVENTION

According to one aspect of the present invention provides a method of extracting a polypeptide from avian eggshell membranes. The method includes fermenting the avian eggshell membranes in a fermentation process, harvesting a fermented product, and processing the fermented product to extract the polypeptide. The polypeptide can include one or more of collagen, hyaluronic acid, glucosamine, chondroitin, lysine, tryptophan, leucine, aspartic acid, praline, isoleucine, threonine, glycine, histidine, arginine, tyrosine, glutamic acid, cystine, alanine, methionine, valine, phenylalanine, and serine. The inoculant used in the fermenting step can be a bacteria, yeast, or mold. For example, the inoculant may be Bactillus subtilus or Pichia pastoris. The step of processing the fermented product will depend upon the product being isolated. The step of processing may include an enzymatic process such as a digestive process. The eggshell membranes used in the process may have been separated from eggshells by placement in an acidic solution.

### BRIEF DESCRIPTION OF THE DRAWINGS

FIG. 1 is a flow chart providing an overview of the present invention.

FIG. 2 is an image from an SDS-PAGE.

FIG. 3 is an image from an SDS-PAGE showing results of SIRCOL testing.

### DETAILED DESCRIPTION OF THE PREFERRED EMBODIMENT

The present invention provides for extraction and isolation of polypeptides of interest from eggshell membranes, including high value materials such as collagen, amino acids, and other materials. The present invention provides for purity levels higher than any known to be previously reported and does so in an industrial context as opposed to only within a research laboratory.

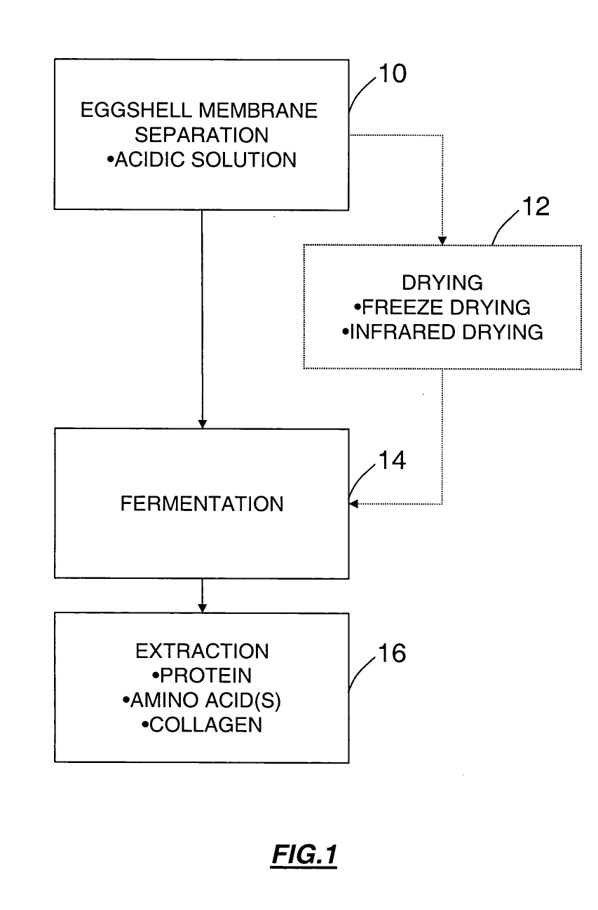

FIG. 1 provides an overview of the present invention. As shown in FIG. 1, in step 10, eggshell membrane separation occurs. This is the process of separating the hard outer shell from the inner membrane. Next, in step 12, drying takes place. The drying can be either freeze drying or thermal drying, or other forms of drying. Preferably, the drying occurs at a temperature less than a threshold temperature which is damaging to what is to be extracted from the eggshell membrane. In step 14, fermentation of the eggshell membranes takes place using any number of inoculants. Then in step 16, extraction of desired polypeptides, such as collagen or high value amino acids, occurs.

Eggshell Membrane Separation

Egg shell membranes are separated from the egg shell. Although this process can be performed in numerous manners, this process is preferably performed in the manner described in U.S. patent application Ser. No.11/333,697, filed Jan. 17, 2006, and entitled EGGSHELL MEMBRANE SEPARATION METHOD or U.S. Provisional Patent Application Ser. No. 60/644,643, filed on Jan. 18, 2005, entitled EGGSHELL MEMBRANE SEPARATION METHOD, both of which are hereby incorporated by reference in their entirety. In such a process, egg shells with attached membranes are placed in an acidic solution such as a solution of acetic acid and distilled water and the solution is stirred. The use of acetic acid is advantageous in that it facilitates the separation of the eggshell from the eggshell membrane by making the eggshell brittle and easily cracked. Furthermore, the immersion of the eggshell membrane in acetic acid causes the collagen to swell. Such a process allows both the egg shell membranes and egg shells to be separately recovered for different purposes. The use of acetic acid in the eggshell separation process is further advantageous in the extraction process as this prior exposure to acetic acid decreases the amount of time required in the extraction process since the acetic acid provides a suitable buffer in which digestive enzymes function. Another advantage of the use of acetic acid is that the acetic acid also destroys bacteria and germs. It has been found that the lower the pH, the better proteins in the eggshell membranes are preserved. It is preferred that the pH be under 5.0 and preferably in the range of about 2.7 to about 5.0 pH. During the Industrial Pilot Plant membranes extraction/evaluation, an electrolytic water low pH (Hoshizaki) was used with very good results. Of course, the present invention contemplates that other forms of eggshell membrane separation techniques may be used. Although it is preferred to use egg shell membranes for the extraction process, the present invention provides that some amount of powderized egg shells can also be used.

Drying

It is also preferred that the egg shell membranes used are dried either through dry freezing or infrared drying. Where egg shell membranes are dried, it is preferred that the drying takes place at or below a temperature of 104 degrees Fahrenheit where collagen is to be extracted. This has been found to be the temperature threshold for melting the helix of collagen.

Fermentation

The process provides for fermenting the eggshell membranes. The fermentation process is used to break down sugars in the egg shell membrane thereby aiding in the protein isolation process. Advantageously, fermentation increases the protein yield as well being environmentally friendly and inexpensive. The present invention contemplates that any number of yeasts, molds, or bacteria can be used as inoculums in the fermentation process. Examples of such inoculums include Bacillus subtilus, Pichia pastoris. Bacillus subtilus is one of the most-studied Gram-positive bacterium and has long been used in food production and industrial scale applications. Pichia pastoris is a well known methylotrophic yeast. The present invention is no way limited to these particular inoculums as the present invention contemplates that other types of yeast, molds, and bacteria can be used for fermentation.

Extraction

After the egg shell membranes are fermented, the resulting product is then processed to extract the polypeptide(s) or other material of interest. The resulting product is a gel-like material which can be dried to form a pellet. The pellet may be lyophilized and purified using dialysis. The present inventor contemplates that processing may include placing the pellet in an acetic acid solution. The pellet may alternately be processed in an acetic acid/pepsin solution which is stirred. Alternatively, other enzymatic processes, including other digestive processes, may be used if desired. The solids can be separated from the solution using a variety of methods, for example, centrifugation or filtration or other processes known to those skilled in the art. The present inventor also contemplates that subsequent to eggshell membrane separation, the extraction process may be directly performed in the absence of fermenting the eggshell membranes.

The identity of the extracted polypeptides may be determined using routine techniques known to one skilled in the art including, for example, western blot analysis, mass spectrometry sequencing, or commercially available assays.

### EXAMPLE 1

A first procedure is provided for using Bacillus subtilus as an inoculum in a fermentation process for extracting collagen from eggshell membranes. To prepare the inoculum, a live agar slant of Bacillus subtilus was obtained from Carolina Biological Supply. A 100 ml flask of Lennox LB base (20 g/L) was prepared and autoclaved. Using aseptic technique the 100 ml flask was inoculated with the B. subtilus. The inoculum was allowed to grow 24 hours at 30° C.

Viritis 2L benchtop fermeters were used for the fermentation procedure. To prepare the fermenters, all fermenters were taken apart and cleaned using ALCOJET powdered detergent. All parts were rinsed three times in DI water before reassembling. To prepare the growth media used, Erlenmeyer flasks (2L), magbars, and magbar stirrers were used to mix and prepare 1000 ml aliquots of Lennox LB base growth media. De-ionized water was used in all runs as the media water base. Once the broth was well mixed it was poured into the fermenters. The fermenters were placed into the autoclave and run at 121.1° C. for 30 minutes.

Using aseptic technique a pre-inoculated sample was removed from the fermenter. A pH was taken of this sample and found to be in the area of 6.8-7.0. The egg shell membrane was dried using a dry freeze method and grinded. Under a HEPA laminar flow hood the fermenter was then loaded with the ‘sanitized’ membrane. A gram stain was performed on the inoculum and it was determined that it contained only gram (+) bacillus indicative of B. subtilus. Using aseptic technique a 10 ml inoculum of B. subtilus was then injected into the fermenter. The operating parameters were set at: RPM=350; Air=2-3 LPM; Temperature=30° C. Approximately 3-5 ml of antifoam was added at this point to all fermenters. The fermentation was allowed to proceed for 24 hours.

Next, various harvest steps occurred. A sample was aseptically removed and a pH was obtained and a gram stain was performed. Pre-harvest pH was typically in the mid to high 8 range. A gram stain was performed to determine if contamination had occurred. The entire contents of the one liter fermenter were then aliquoted into 500 ml centrifuge tubes. The tubes were then spun at 5000 RCF for 20 minutes. The supernatant was decanted and the pellet was resuspened and rinsed in sterile DI water and re-centrifuged. This was repeated one more time for a total of two rinses. The final rinse was decanted and the pellet was dried between paper towels and then weighed.

After harvest, exemplary downstream processing steps were performed. The weight of the pellet was used to determine the amount of 0.5 M acetic acid/1% pepsin solution to be prepared. The weight of the pellet was to be 3% (w/v) of the total acetic acid/pepsin mixture. The pellet was then placed into this acid/pepsin solution and gently stirred for 16 hours @ 4° C. The solids were removed from the acid/pepsin mixture using centrifugation at 5000 RCF for 20 minutes @ 4° C. The supernatant was decanted and saved, the solids were discarded. The supernatant was treated with 5 g/L activated charcoal for 20 minutes @ 4° C. The charcoal was then removed by centrifugation at 5000 RCF for 50 minutes @ 4° C. Again the supernatant was decanted and saved and the charcoal pellet was discarded. The cold supernatant was then poured into an Erlenmeyer flask with magbar and placed on a magnetic stirrer. The cold solution was then gently stirred while NaCl was added at a concentration of 50 g/L. Once all the salt was in solution the magbar was removed. This acid/salt solution was then placed into the 4° C. refrigerator overnight (24 hrs) undisturbed. The entire contents of the flask was then filtered using dialysis with a membrane mesh of 10 microns. The concentrated fluids were then aliquoted into plastic beakers at 20 ml/beaker and filter paper lids were affixed. The beakers were then placed into the sharp freezer until frozen. The now frozen beakers were placed into the freeze dryer and allowed to dry for 48-72 hours. The dry collagen was then combined and weighed.

### EXAMPLE 2

A second procedure is provided for using Pichia pastoris as an inoculum in a fermentation process for extracting collagen from eggshell membranes.

First the Pichia pastorsis inoculum was prepared. A live agar slant of Pichia pastoris was obtained from DSMZ. A 100 ml flask of Lennox LB base (20 g/L) was prepared and autoclaved. Using aseptic technique the 100 ml flask was inoculated with the P. pastoris. The inoculum was allowed to grow 24 hours @ 30° C. Viritis 2L benchtop fermenters were then prepared. All fermenters were taken apart and cleaned using ALCOJET powdered detergent. All parts were rinsed three times in DI water before reassembling. In addition, the growth media was prepared. Erlenmeyer flasks (2L), magbars, and magbar stirrers were used to mix and prepare 1000 ml aliquots of Lennox LB base growth media. De-ionized water was used in all runs as the media water base. Once the broth was well mixed it was poured into the fermenters. The fermenters were placed into the autoclave and run @ 121.1° C. for 30 minutes.

Using aseptic technique a pre-inoculated sample was removed from the fermenter. A pH was taken of this sample and found to be in the area of 6.8-7.0. The egg membranes were dried using dry freeze methods and were grinded. a HEPA laminar flow hood the fermenter was then loaded with the ‘sanitized’ membrane. A gram stain was performed on the inoculum and to determined if it contained any contaminants. Using aseptic technique a 10 ml inoculum of P. pastoris was then injected into the fermenter. The operating parameters were set at: RPM=350; Air=2-3 LPM; Temperature=30° C. Approximately 3-5 ml of antifoam was added at this point to all fermenters. The fermentation was allowed to proceed for 24 hours.

Next, various harvest steps occurred. A sample was aseptically removed and a pH was obtained and a gram stain was performed. Pre-harvest pH was typically in the mid to high range. A gram stain was performed to determine if contamination had occurred. The entire contents of the one liter fermenter were then aliquoted into 500 ml centrifuge tubes. The tubes were then spun at 5000 RCF for 20 minutes. The supernatant was decanted and the pellet was resuspened and rinsed in sterile DI water and re-centrifuged. This was repeated one more time for a total of two rinses. The final rinse was decanted and the pellet was dried between paper towels and then weighed.

After harvest, exemplary downstream processing steps were performed. The weight of the pellet was used to determine the amount of 0.5M acetic acid/1% pepsin solution to be prepared. The weight of the pellet was to be 3% (w/v) of the total acetic acid/pepsin mixture. The pellet was then placed into this acid/pepsin solution and gently stirred for 16 hours @ 4° C. The solids were then removed from the acid/pepsin mixture using centrifugation at 5000 RCF for 20 minutes @ 4° C. The supernatant was decanted and saved, the solids were discarded. The supernatant was treated with 5 g/L activated charcoal for 20 minutes @ 4° C. The charcoal was then removed by centrifugation at 5000 RCF for 50 minutes @ 4° C. Again the supernatant was decanted and saved and the charcoal pellet was discarded. The cold supernatant was then poured into an Erlenmeyer flask with magbar and placed on a magnetic stirrer. The cold solution was then gently stirred while NaCl was added at a concentration of 50 g/L. Once all the salt was in solution the magbar was removed. This acid/salt solution was then placed into the 4° C. refrigerator overnight (24 hrs) undisturbed. The entire contents of the flask was then filtered using dialysis with a membrane mesh of 10 microns. The concentrated fluids were then aliquoted into plastic beakers at 20 ml/beaker and filter paper lids were affixed. The beakers were then placed into the sharp freezer until frozen. The now frozen beakers were placed into the freeze dryer and allowed to dry for 48-72 hours. The dry collagen was then combined and weighed.

The present invention also allows for only membranes without shells to be used, a high percent shell and low percent membrane mixture to be used or other combinations of shells and membranes. Different trials have been run for different inoculants and different levels of egg shells with the membranes. The resulting protein has then been analyzed.

### EXAMPLE 3

Different samples of extracted material were also tested for collagen content. The test protocol included weighing out samples to achieve 100 mg/mL in DI water. The below table illustrates four of the samples used. Sample A is of membranes fermented using B. subtilus. Sample B is of membranes fermented with P. pastoris. Sample C is of a combination of 90 percent membranes and 10 percent egg shells fermented with B. subtilus. Sample D is of powderized egg shells fermented with B. subtilus.

| | | | Nanodrop | Final |
|---|---|---|---|---|
| | | DI water | concen- | Concen- |
| Sample | Weight | added | tration | tration |
| A-Membrane | 966 mg | 9.66 mL | 1.76 mg/mL | 8.8 μg/μL |
| B. subtilus | | | | |
| B-Membrane | 848 mg | 8.48 mL | 3.02 mg/mL | 15.5 μg/μL |
| P. pastoris | | | | |
| C-90/10 | 1038 mg | 10.38 mL | 1.25 mg/mL | 6.25 μg/μL |
| B. subtilus | | | | |
| D-Shells | 1333 mg | 13.33 mL | 3.11 mg/mL | 15.55 μg/μL |
| B. subtilus | | | | |

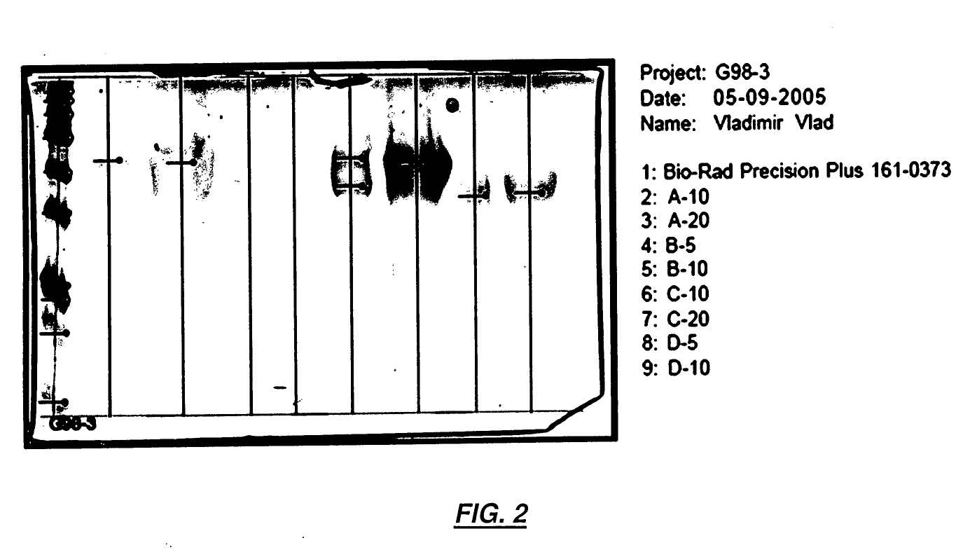

SDS-PAGE was performed. The protocol included preparing a gel comprising: resolving gel, 12% acrylamide; stacking gel, 4% acrylamide, running buffer, 25 mM Tris-HCl, 192 mM glycine, 0.1% SDS, pH 8.3. SpeedVac 500 μL of each sample to dryness. Add 50 μL of DI water to dried sample and heat at 30° C. for 1 hour. Add 50 μL of Collagen buffer to each sample, heat at 100° C. for 5 minutes. Load 10 μL of BioRad Molecular Weight Markers Cat. No. 161-0373 in Lane 1. Load sample according to loading chart to achieve a load of ˜80 μg and ˜160 μg. Running conditions: 180 V for 60 min. Stain 45 min in Coomassie Blue, followed by two changes in destain solutions, one hour each. Scan gels after soaking in water, print images and analyze. A resulting image is shown in FIG. 2. A loading chart for the SDS-PAGE protocol is provided below.

| | Lane | | | | | | | | |
|---|---|---|---|---|---|---|---|---|---|
| | 1 | 2 | 3 | 4 | 5 | 6 | 7 | 8 | 9 |
| Sample | MW | A | A | B | B | C | C | D | D |
| μL | 10 | 10 | 20 | 5 | 10 | 10 | 20 | 5 | 10 |
| μg | — | 88.0 | 176.0 | 77.5 | 155.0 | 62.5 | 125.0 | 77.8 | 155.6 |

Also, the collagen buffer included a 0.063M TrisHCl (pH 6.8), 3.3% (w/v) SDS, 10% (v/v) glycerol, 5% (v/v) 2-mercaptoethanol, and 0.001% (w/v) bromophenol blue. The coomassie blue included 0.1% (w/v) Coomassie Brilliant Blue R-250/50% methanol/10% acetic acid/water. The destain solution included 50% methanol/10% acetic acid/water. As shown in FIG. 2, the image indicates that the gel indicates the presence of polypeptides in the sample. Also, a UV-VIS test indicated that the resulting material is protein.

### EXAMPLE 4

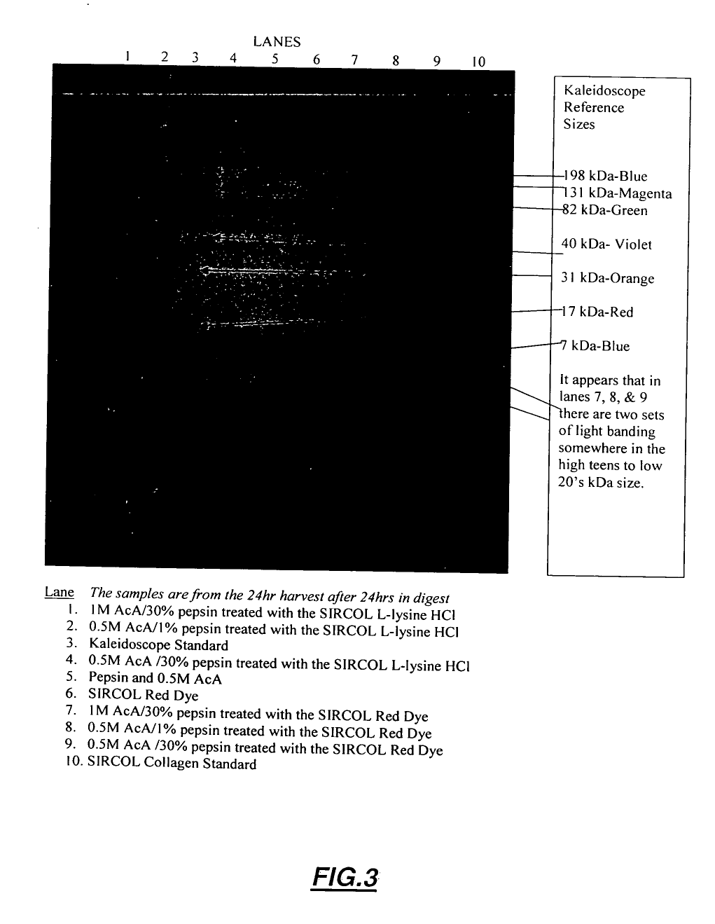

Testing for collagen has also been performed using Sircol, a soluble collagen assay. The Sircol collagen assay is a quantitative dye-binding method for analysis of acid-soluble collagens. FIG. 3 illustrates results of an SDS-PAGE. The samples are from the 24 hour harvest after 24 hours in digestion. Lane 1 indicates 1M AcA/30% pepsin treated with the SIRCOL L-lysine HCl. Lane 2 indicates 0.5M AcA/1% pepsin treated with the SIRCOL L-lysine HCl. Lane 3 indicates the Kaleidoscope Standard. Lane 4 indicates 0.5M AcA/30% pepsin treated with the SIRCOL L-lysine HCl. Lane 5 indicates Pepsin and 0.5M AcA. Lane 6 indicates SIRCOL Red Dye. Lane 7 indicates 1M AcA/30% pepsin treated with the SIRCOL Red Dye. Lane 8 indicates 0.5M AcA/1% pepsin treated with the SIRCOL Red Dye. Lane 9 indicates 0.5M AcA /30% pepsin treated with the SIRCOL Red Dye. Lane 10 indicates the SIRCOL Collagen Standard.

Based on the results of the test it is shown that collagen is present at high levels. Its purity being in the range of 130 to 140 kDa. Collagen has been extracted at levels of 27 percent.

### EXAMPLE 5

The present invention provides for numerous variations to be used in the downstream processing, depending upon the material to be extracted. Examples of downstreaming processing, include that disclosed in U.S. Pat. No. 6,899,294 to MacNeil, and US2004/0180025 to Long et al, herein incorporated by reference in their entirety. The present invention provides for a practical means to isolate collagen and other high value products from eggshell waste using conventional methods and on an industrial scale. Examples of one measure of the amount of polypeptides known to be found in egg shell membranes are shown below from MacNeil.

| | |
|---|---|
| Protein | 85 |
| Lysine | 3.35 |
| Histidine | 3.48 |
| Arginine | 6.46 |
| Threonine | 4.60 |
| Glutamic Acid | 9.70 |
| Proline | 9.34 |
| Glysine | 4.94 |
| Cysteine | 8.50 |
| Valine | 6.30 |
| Methionine | 3.09 |
| Isoleucine | 3.19 |
| Leucine | 4.30 |
| Tyrosine | 1.73 |
| Phenylalanine | 1.65 |

Another measure of the typical amino acid composition of egg shell membranes is provided by Long et al and is set forth in the below table:

| | |
|---|---|
| Lysine | 2.88 |
| Tryptophan | 2.51 |
| Leucine | 3.85 |
| Aspartic Acid | 7.01 |
| Proline | 8.23 |
| Isoleucine | 2.01 |
| Threonine | 4.42 |
| Glycine | 3.99 |
| Histidine | 2.79 |
| Arginine | 5.33 |
| Tyrosine | 1.33 |
| Glutamic Acid | 8.23 |
| Cystine | 6.01 |
| Alanine | 2.00 |
| Methionine | 2.85 |
| Valine | 5.13 |
| Phenylalanine | 1.48 |
| Serine | 4.28 |

One measure of the constituents of egg shell membranes (in percentage) is provided by Long et al and is set forth in the below table:

| | |
|---|---|
| Collagen | 35 |
| Glucosamine | 10 |
| Chondroitin | 9 |
| Hyaluronic acid | 5-10 |

Testing on the egg shell membranes of the present invention has provided significantly improved results over that achieved by the prior art. In fact, the present invention provides for over 90 percent protein. This level of protein isolation or purification is not found in any known prior art. It is of further significance that levels of 90 percent are consistently achieved in an industrial scale process. The below table provides results of testing by Eurofins Laboratories, Inc. on the Inventor's eggshell membranes showing median production of amino acids.

| | |
|---|---|
| Protein | 90.08 |
| Aspartic Acid | 7.98 |
| Threonine | 5.19 |
| Serine | 5.05 |
| Glutamic Acid | 11.91 |
| Proline | 10.79 |
| Glycine | 5.43 |
| Alanine | 2.46 |
| Valine | 6.02 |
| Isoleucine | 2.91 |
| Leucine | 4.19 |
| Tyrosine | 1.57 |
| Phenylalanine | 1.60 |
| Lysine | 3.21 |
| Histidine | 3.38 |
| Arginine | 6.89 |
| Cystine | 6.72 |
| Methionine | 3.50 |
| Tryptophan | 3.64 |

Thus, there are numerous types of polypeptides in eggshell membranes that can be extracted in the downstream processing steps. The present invention, for example, contemplates that any number of appropriate enzymatic processing steps may be applied using any number of enzymes. For example, the majority of the collagens in eggshell membrane can be recovered using limited digestion with pepsin or other proteolytic enzymes under conditions permitting limited digestion, e.g. in 0.5 M acid acetic, pH 3.0. Digestion occurs for at least 2 hours and preferably up to 12 hours. Using this method partially degrades the collagen allowing it to be solubilized while completely degrading other protein types. The solubilized collagen can undergo serial salt fractionations at acid pH conditions for preferential precipitation of different types of collagen using a range of 0.5M to 1.5M NaCl. Precipitated collagen can be centrifuged to separate it from non-precipitated material, re-dissolved in acid-containing solutions and precipitated with a salt solution, preferably NaCl. This procedure can be repeated several times to purify the collagen. Further purification of the collagens recovered in the selective precipitation procedures can be achieved by chromatography on carboxymethyl-cellulose in native form. This procedure can resolve the collagen fractions based on salt-gradient elution. In another example, it is well known that protein-containing material can be reduced to individual amino acids by the application of heat (100 C) at an acid pH (<2.0).

The individual amino acids can be isolated using conventional High Pressure Liquid Chromatography separating molecules based on charge and/or hydrophobicity. Preferably, membrane filtration (such as nanofiltration or ultrafiltration) is used.

Applications

The present invention contemplates numerous uses of the extracted collagen, amino acids, or other polypeptides. Cosmetic or pharmaceutical products may be manufactured which include collagen isolated by the present invention. Such cosmetic or pharmaceutical products would include a cosmetically or pharmaceutically acceptable excipient in addition to the collagen. In addition, the collagen of the present invention may be used in any number of applications where collagen is present. Methods and means for the preparation of a pharmaceutically acceptable excipient for the delivery of polypeptides of the present invention will be readily apparent to one skilled in the art. See, for example, Remington's Pharmaceutical Sciences, the disclosure of which is incorporated herein in its entirety. The extracted polypeptides of the invention may be suitable for use in cosmetic or medicinal treatments or products.

The amino acids of the present invention, where extracted, may also be used in any number of applications. It should be apparent that the present invention not only provides a method of producing collagen, amino acids, or other polypeptides from eggshell waste, but that the method can be implemented on an industrial scale to greatly increase supply of these high value materials for numerous other applications, many of which have yet to be contemplated due to the present scarceness of these materials.

Numerous modifications and variations of the present invention should be apparent to one of skill in the art. Such modifications and variations, including the manner in which egg shell membranes are separated, the manner in which egg shell membranes are fermented, processing steps occurring after fermentation, the particular type of polypeptides harvested such as collagen, amino acids, or other types of proteins. These and other variations are all within the spirit and scope of the invention.

What is claimed is:

1. A method of extracting a polypeptide from avian eggshell membranes, comprising:
fermenting the avian eggshell membranes in a fermentation process;
harvesting a fermented product;
processing the fermented product to extract the polypeptide.

2. The method of claim 1 wherein the polypeptide is collagen.

3. The method of claim 1 wherein the step of fermenting is fermenting with a Bactillus subtilus inoculant.

4. The method of claim 1 wherein the step of fermenting is fermenting is a Pichia pastoris inoculant.

5. The method of claim 1 wherein the polypeptide is hyaluronic acid.

6. The method of claim 1 wherein the step of processing includes an enzymatic process.

7. The method of claim 6 wherein the enzymatic process is a digestive process.

8. The method of claim 1 wherein the eggshell membranes have been separated from eggshells by placement in an acidic solution.

9. The method of claim 8 wherein the acidic solution comprises acetic acid.

10. The method of claim 1 wherein the polypeptide is an amino acid.

11. The method of claim 1 wherein the polypeptide is within the set consisting of lysine, tryptophan, leucine, aspartic acid, praline, isoleucine, threonine, glycine, histidine, arginine, tyrosine, glutamic acid, cystine, alanine, methionine, valine, phenylalanine, and serine.

12. The method of claim 1 wherein the polypeptide is within the set consisting of collagen, glucosamine, chondroitin, and hyaluronic acid.

13. A polypeptide isolated by the method of claim 1.

14. The method of claim 1, wherein the polypeptide is collagen.

15. The method of claim 14 wherein the collagen is Type I, V, or X.

16. A cosmetic or pharmaceutical product comprising:
collagen isolated from avian eggshell membranes, wherein said collagen has been obtained by fermenting avian eggshell membranes in a fermentation process, harvesting a fermented product, and processing the fermented product to extract the polypeptide; and
a cosmetically or pharmaceutically acceptable excipient.

17. The cosmetic or pharmaceutical product of claim 16, which is a biomaterial.

18. The cosmetic or pharmaceutical product of claim 16, where the collagen is Type I, V, or X.

19. Isolated collagen obtained from avian eggshell membranes, wherein said collagen has been obtained by fermenting avian eggshell membranes in a fermentation process, harvesting a fermented product, processing the fermented product to extract the polypeptide.

20. The isolated collagen of claim 19, wherein the collagen is Type I, V, or X.

21. The isolated collagen of claim 19, wherein the collagen being substantially free from pathogens.

22. A method of extracting a polypeptide from avian eggshell membranes, comprising:
separating avian eggshell membranes from avian eggshells by placement in an acidic solution;
harvesting a product;
processing the product to extract a polypeptide.

23. The method of claim 22 wherein the acidic solution comprises acetic acid.

24. The method of claim 22 wherein the step of processing includes an enzymatic process.

25. The method of claim 24 wherein the enzymatic process is a digestive process.

26. A polypeptide isolated by the method of claim 21.

27. The method of claim 25, wherein the collagen is Type I, V, or X.

28. A cosmetic or pharmaceutical product comprising:
collagen isolated from avian eggshell membranes, wherein said collagen has been obtained by separating avian eggshell membranes from avian eggshells by placement in an acidic solution, harvesting a product, and processing the product to extract a polypeptide; and
a cosmetically or pharmaceutically acceptable excipient.

29. The cosmetic or pharmaceutical product of claim 28 wherein the acidic solution comprises acetic acid.
